(19) United States
(12) Patent Application Publication
(10) Pub. No.: US 2010/0220301 A1
(43) Pub. Date: Sep. 2, 2010

(54) APPARATUS AND METHOD TO CONTROL LIQUID STAGNATION IN IMMERSION LIQUID RECOVERY

(75) Inventors: Alex Ka Tim POON, San Ramon, CA (US); Leonard Wai Fung KHO, San Francisco, CA (US); Derek COON, Redwood City, CA (US); Gaurav KESWANI, Fremont, CA (US)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/691,173

(22) Filed: Jan. 21, 2010

Related U.S. Application Data
(60) Provisional application No. 61/202,432, filed on Feb. 27, 2009.

(51) Int. Cl. G03B 27/52

(52) U.S. Cl. 355/30

(57) ABSTRACT

An immersion liquid confinement apparatus confines an immersion liquid in an immersion area that includes a gap between a projection system and an object of exposure in an immersion lithography system. The apparatus also recovers the immersion liquid from the immersion area. The apparatus includes a confinement member and a liquid-permeable member. The confinement member includes an outlet and an aperture through which a patterned image is projected onto the object. The liquid-permeable member covers the outlet and has a first surface that faces the object and a second surface opposite the first surface, the second surface contacting a chamber. The confinement member includes at least one liquid inlet within the chamber through which a liquid is introduced into the chamber to reduce liquid from becoming stagnated within the chamber.

### CROSS-REFERENCE TO RELATED APPLICATIONS

This application claims the benefit of U.S. Provisional Patent Application No. 61/202,432 filed Feb. 27, 2009, the disclosure of which is incorporated herein by reference in its entirety.

### BACKGROUND

The invention relates to immersion lithography apparatus and methods, and particularly to apparatus and methods for recovering immersion fluid.

A typical lithography apparatus includes a radiation source, a projection optical system and a substrate stage to support and move a substrate to be imaged. A radiation-sensitive material, such as a resist, is coated onto the substrate surface before the substrate is placed on the substrate stage. During operation, radiation energy from the radiation source is used to project an image defined by an imaging element through the projection optical system onto the substrate. The projection optical system typically includes a plurality of lenses. The lens or optical element closest to the substrate can be referred to as the last or final optical element.

The projection area during exposure is typically much smaller than the surface of the substrate. The substrate therefore is moved relative to the projection optical system in order to pattern the entire surface of the substrate. In the semiconductor industry, two types of lithography apparatus are commonly used. With so-called “step-and-repeat” apparatus, the entire image pattern is projected at one moment in a single exposure onto a target area of the substrate. After the exposure, the substrate is moved or “stepped” in the X and/or Y direction(s) and a new target area is exposed. This step-and-repeat process is performed multiple times until the entire substrate surface is exposed. With scanning type lithography apparatus, the target area is exposed in a continuous or “scanning” motion. For example, when the image is projected by transmitting light through a reticle or mask, the reticle or mask is moved in one direction while the substrate is moved in either the same or the opposite direction during exposure of one target area. The substrate is then moved in the X and/or Y direction(s) to the next scanned target area. The process is repeated until all of the desired target areas on the substrate have been exposed.

Lithography apparatus are typically used to image or pattern semiconductor wafers and flat panel displays. The word “substrate” as used herein is intended to generically mean any workpiece that can be patterned including, but not limited to, semiconductor wafers and flat panel displays.

Immersion lithography is a technique that can enhance the resolution of lithography exposure apparatus by permitting exposure to take place with a numerical aperture (NA) that is greater than the NA that can be achieved in conventional “dry” lithography exposure apparatus having a similar optical system. By filling the space between the final optical element of the projection system and the resist-coated substrate, immersion lithography permits exposure with light that would otherwise be internally reflected at the optic-air interface. Numerical apertures as high as the index of the immersion fluid (or of the resist or lens material, whichever is least) are possible in immersion lithography systems. Liquid immersion also increases the substrate depth-of-focus, that is, the tolerable error in the vertical position of the substrate, by the index of the immersion fluid compared to a dry system having the same numerical aperture. Immersion lithography thus can provide resolution enhancement without actually decreasing the exposure light wavelength. Thus, unlike a shift in the exposure light wavelength, the use of immersion would not require the development of new light sources, optical materials (for the illumination and projection systems) or coatings, and can allow the use of the same or similar resists as conventional “dry” lithography at the same wavelength. In an immersion system in which only the final optical element of the projection system and its housing and the substrate (and perhaps portions of the stage as well) are in contact with the immersion fluid, much of the technology and design developed for dry lithography can carry over directly to immersion lithography.

However, because the substrate moves rapidly in a typical lithography system, the immersion liquid in the immersion area including the space between the projection system and the substrate tends to be carried away from the immersion area. If the immersion liquid escapes from the immersion area, that liquid can interfere with operation of other components of the lithography system. One way to recover the immersion liquid and prevent the immersion liquid from contaminating the immersion lithography system is described in US2006/0152697 A1, the disclosure of which is incorporated herein by reference in its entirety. Also see US2007/0222967 A1, the disclosure of which is incorporated herein by reference in its entirety.

The systems described in US2006/0152697 A1 and US2007/0222967 A1 include an immersion liquid confinement member. The immersion liquid confinement member includes an outlet through which immersion liquid is recovered (collected) from the immersion area. The outlet is covered by a liquid-permeable member such as a mesh or porous member. A vacuum control unit applies suction to a chamber associated with the outlet so as to draw the immersion liquid on the substrate through the liquid-permeable member and the outlet. It is important to control the suction force applied to the liquid-permeable member.

In the systems described above, there are a limited number of outlets in the immersion liquid confinement member. Due to the limited number of outlets, areas of stagnated liquid occur in the chamber associated with the outlet. These areas of stagnated liquid can be caused, for example, by eddy currents in the liquid that trap the liquid in certain areas of the chamber. During normal operation of an immersion lithography system, particles from the resist and the topcoat on the wafer may leech into the immersion fluid. As the immersion fluid is drawn into the chamber through the liquid-permeable member, some of the liquid containing the particles stagnates in the certain areas of the chamber due to the above-mentioned eddy currents. The particles can collect in the areas of the chamber in which the liquid stagnates, and such particles can pass back through the liquid-permeable member to contaminate the liquid that contacts the substrate and the final optical element of the projection system. Such contamination can lead to defects in the devices produced by the lithography system. It is therefore important to remove any particles from the immersion fluid quickly and to reduce liquid stagnation in the chamber associated with the outlet.

### SUMMARY

According to aspects of the invention, an immersion liquid confinement apparatus includes a confinement member having a liquid-permeable member to remove liquid from an immersion area that includes a gap between a projection system and an object (such as a substrate, a substrate holding table or both) in an immersion lithography system. The liquid-permeable member covers an outlet in the confinement member and has a first surface that faces the object and a second surface opposite the first surface and which is in contact with a first chamber. The confinement member includes at least one liquid inlet within the chamber through which a liquid is introduced into the chamber.

Introducing liquid into the liquid recovery chamber prevents liquid from stagnating within the chamber and thus flushes recovered liquid and particles that have passed through the liquid-permeable member out of the chamber.

According to another aspect of the invention, the confinement member can include two or more liquid inlets within the chamber.

In some embodiments, the confinement member includes at least one fluid outlet within the chamber through which fluid is removed from the chamber, the at least one liquid inlet being disposed within the chamber spaced away from the at least one fluid outlet.

The liquid inlet can be disposed at an outer periphery of the chamber and/or in at least one wall of the chamber.

In some embodiments, the liquid inlet can be located at a position in the chamber where the immersion liquid that has passed through the liquid-permeable member stagnates.

In some embodiments, the confinement member can include an immersion liquid inlet that is outside of the chamber and that provides immersion liquid to the aperture through which the patterned image is projected onto the object.

According to preferred embodiments, a vacuum system is coupled to the chamber. The vacuum system, coupled to the chamber, draws the immersion liquid from the immersion area into the chamber through the liquid-permeable member so that the liquid flows from the first surface of the liquid-permeable member to the second surface of the liquid-permeable member. Liquid is conveyed from the chamber to the vacuum system via a fluid outlet of the chamber.

The chamber of the confinement member can include corners and the at least one liquid inlet can be configured to provide liquid to the corners of the chamber.

The liquid-permeable member can be a mesh or a porous member such as a sponge or a plate having holes extending through the plate.

Other aspects of the invention relate to an immersion lithography apparatus having a projection system, a movable stage that is movable to a position below the projection system and that holds an object such as a substrate, and a confinement member according to aspects of the invention.

Other aspects of the invention relate to methods of manufacturing devices using the immersion lithography apparatus.

### BRIEF DESCRIPTION OF THE DRAWINGS

The invention will be described in conjunction with the following drawings of exemplary embodiments in which like reference numerals designate like elements, and in which:

FIG. 1 is a simplified elevational view schematically illustrating an immersion lithography system according to some embodiments of the invention;

FIG. 2 is a simplified side cross-sectional view of a liquid confinement member and its fluid removal system according to a first embodiment of the invention;

FIG. 3 is a simplified perspective view of a liquid confinement member according to a second embodiment of the invention;

FIG. 4 is a simplified plan view of a liquid confinement member illustrating stagnated liquid in the chamber;

FIG. 5 is a simplified plan view of a liquid confinement member illustrating a fluid flow so as to prevent liquid stagnation according to an embodiment of the invention;

FIG. 6 is a flowchart that outlines a process for manufacturing a device in accordance with the invention; and

FIG. 7 is a flowchart that outlines device processing in more detail.

### DETAILED DESCRIPTION OF EMBODIMENTS

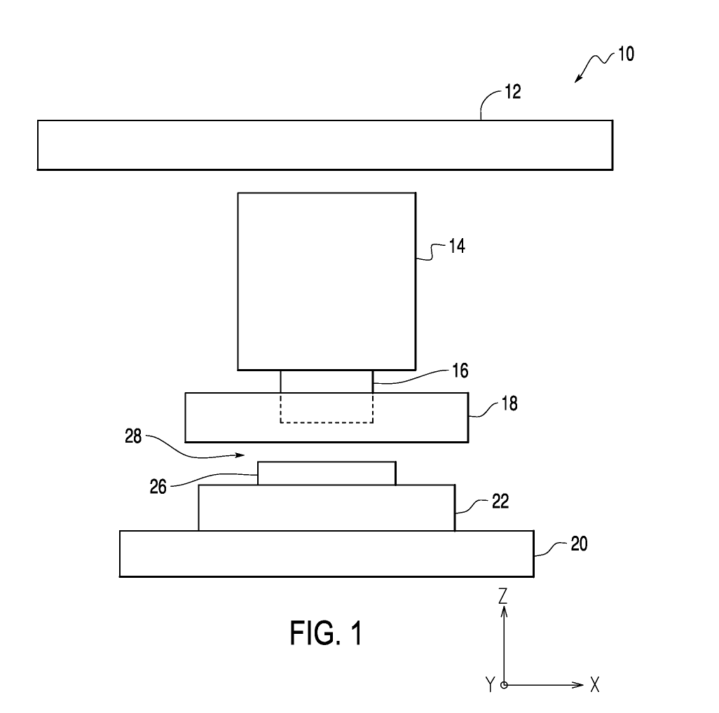

FIG. 1 shows an immersion lithography system 10 including a reticle stage 12 on which a reticle is supported, a projection system 14 having a last or “final” optical element 16, and a fine-movement stage 22 on which a substrate 26 is supported, which in turn is movable over a coarse-movement stage 20. An immersion liquid supply and recovery apparatus 18, which is sometimes referred to herein as a liquid confinement member 18, is disposed around the final optical element 16 of the projection system 14 so as to supply and recover an immersion fluid, which may be a liquid such as, for example, water, to/from a gap 28 between the final optical element 16 and the substrate 26. In the present embodiment, the immersion lithography system 10 is a scanning lithography system in which the reticle and the substrate 26 are moved synchronously in respective scanning directions during a scanning exposure operation. The fine-movement stage 22 controls the position of the substrate 26 in one or more (preferably all) of the X, Y, Z, θX, θY and θZ directions with a higher degree of precision than the coarse-movement stage 20, which is primarily used for moving the substrate 26 over longer distances, as is well known in the art. The upper surface of the fine movement stage 22 includes a substrate holder that preferably has a recess that holds the substrate 26. In addition, a portion of the upper surface of the fine movement stage 22 that surrounds the held substrate has an upper surface that is substantially level with the upper surface of the held substrate so that when the immersion area is located near the edge of the substrate, liquid is still maintained between the liquid confinement member 18 and the upper surfaces of the substrate 26 and of the substrate holder.

The illumination source of the lithography system can be a light source such as, for example, a mercury g-line source (436 nm) or i-line source (365 nm), a KrF excimer laser (248 nm), an ArF excimer laser (193 nm) or a F₂ laser (157 nm). The projection system 14 projects and/or focuses the light passing through the reticle onto the substrate 26. Depending upon the design of the exposure apparatus, the projection system 14 can magnify or reduce the image illuminated on the reticle. It also could be a 1× magnification system.

When far ultraviolet radiation such as from the excimer laser is used, glass materials such as silica glass and calcium fluoride that transmit far ultraviolet rays can be used in the projection system 14. The projection system 14 can be catadioptric, completely refractive or completely reflective.

With an exposure device, use of the catadioptric type optical system can be considered. Examples of the catadioptric type of optical system are shown in U.S. Pat. No. 5,668,672 and U.S. Pat. No. 5,835,275. In these cases, the reflecting optical device can be a catadioptric optical system incorporating a beam splitter and concave mirror. U.S. Pat. No. 5,689,377 also uses a reflective-refracting type of optical system incorporating a concave mirror, etc., but without a beam splitter, and also can be employed with this invention. The disclosures of the above-mentioned U.S. patents are incorporated herein by reference in their entireties.

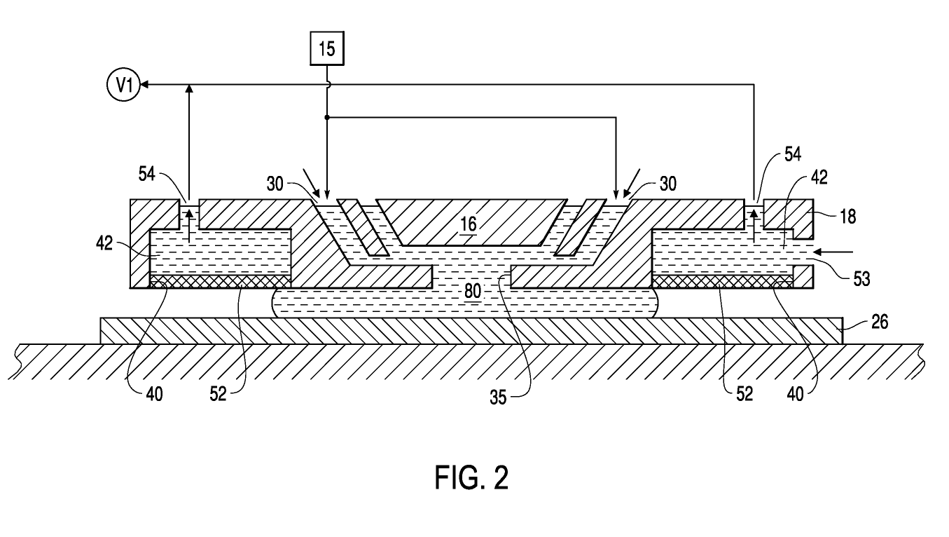

FIG. 2 is a cross-section view of an embodiment of a liquid confinement member 18. As shown in FIG. 2, the liquid confinement member 18 maintains immersion liquid 80 in an immersion area, which includes the gap or space between the final optical element 16 of the projection system 14 and a portion of the upper surface of the substrate 26. The immersion liquid 80 in FIG. 2 can be seen as occupying only a portion of the upper surface of the substrate 26. That is, the size of the immersion area is smaller than the size of the upper surface of the substrate 26 such that only part of the upper surface of the substrate is covered. Depending on the relative position of the substrate 26 with respect to the projection system 14 (and the liquid confinement member 18) the immersion area can be disposed over the substrate, over a portion of the substrate and a portion of the substrate holder that surrounds the substrate, or over only a portion of the substrate holder (for example, when the substrate is moved such that it no longer is disposed below the projection system 14). In addition, if the exposure apparatus includes a measurement stage that is used to take measurements regarding the projection system 14, the immersion area can be formed between an upper surface of the measurement stage and the final optical element 16 (there would be no substrate holder on the measurement stage).

The liquid confinement member 18 includes at least one (and preferably more than one) liquid supply inlets 30 through which the immersion liquid 80 is supplied to the immersion area. The liquid is supplied to the supply inlets 30 through a supply path, one end of which is connected to a liquid supply 15 and the other end of which is connected to an inlet manifold of the liquid confinement member 18. The liquid supplied to the supply inlets 30 reaches the substrate 26 after passing through aperture 35 disposed centrally in the confinement member 18. As shown in FIG. 2, the supply and recovery of the immersion liquid is controlled so that the level of the immersion liquid between the liquid confinement member 18 and the final optical element 16 is maintained above the lower surface of the final optical element 16 so that the exposure light transmitted through the projection system 14 travels only through the immersion liquid (that is, the exposure light does not travel through any air or gas) before reaching the substrate 26.

In the FIG. 2 embodiment, the liquid confinement member 18 includes an outlet 40. In the FIG. 2 embodiment, the outlet 40 is an annular groove that surrounds aperture 35, and thus also surrounds the immersion area. Liquid is removed from the immersion area and from the surface of the substrate 26 (and/or the surface of the substrate holder) via the outlet 40. The outlet 40 is covered by a liquid-permeable member 52 such that a chamber 42 is disposed within the liquid confinement member 18. A first (lower) surface of the liquid-permeable member 52 faces toward the substrate 26, whereas a second (upper) surface of the liquid-permeable member 52 contacts the chamber 42. Liquid that passes through the liquid-permeable member 52 from its first surface to its second surface thus enters the chamber 42.

Although the outlet 40 (and thus also the liquid-permeable member 52) is a continuous groove in FIG. 2, the outlet 40 (and thus the liquid-permeable member 52 covering the outlet) could be a series of arc-shaped portions, straight portions or angled portions that collectively surround the immersion area and communicate with chamber 42. Furthermore, the outlet could be circular in plan view, rectangular or any other shape in plan view.

As illustrated in FIG. 2, the chamber 42 includes at least one liquid inlet 53 that can be disposed within a wall of the chamber 42. When the outlet 40 is rectangular in plan view, the chamber 42 also may be rectangular and thus have corners, and it is preferred that the liquid inlet 53 is positioned such that the supply of liquid through the liquid inlet 53 is provided to one or more corners of the chamber 42 of the confinement member 18. The liquid inlet 53 can be provided at an outer periphery of the chamber 42. For example, the embodiment in FIG. 2 illustrates the liquid inlet 53 being spaced apart from the outlet 40. Further, the immersion liquid inlet(s) 30 is/are distinct and separate from the liquid inlet 53 such that the immersion liquid inlets 30 are disposed closer to the aperture 35 than the liquid inlet 53.

In the embodiment illustrated in FIG. 2, the chamber 42 includes three liquid inlets 53. There can be any number of liquid inlets 53 as are desired to reduce liquid flow stagnation in the chamber 42. The liquid inlet(s) 53 can be supplied with liquid from liquid supply 15, or a separate liquid supply can be provided for liquid inlet(s) 53.

Although the liquid inlet 53 is illustrated as being substantially horizontal in FIG. 2, the direction of the liquid inlet 53 can be inclined so long as the liquid inlet 53 provides a flow of liquid to areas of liquid stagnation within the chamber 42.

Liquid can be either continuously supplied through liquid inlet 53 to the chamber 42 or can be intermittently supplied to the chamber 42. For example, a valve can be provided between the liquid supply and the liquid inlet(s) 53 to control the flow of liquid through liquid inlet(s) 53.

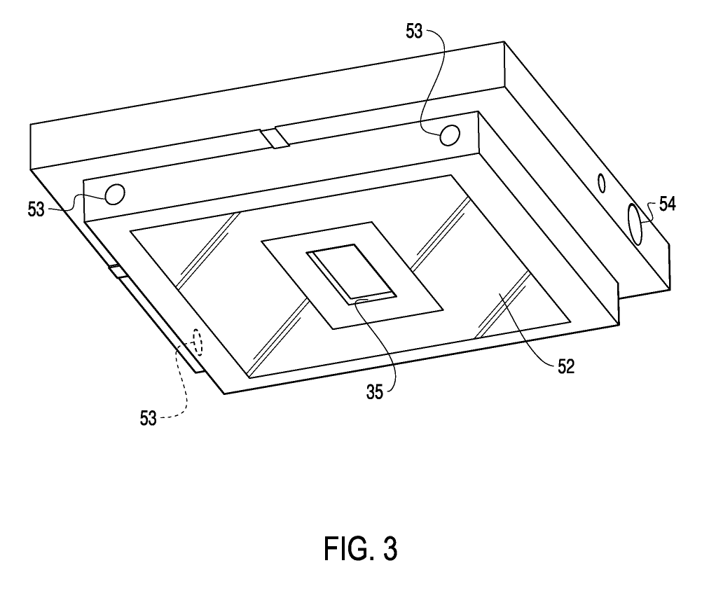

FIG. 3 illustrates a simplified bottom perspective view of the confinement member 18 according to one embodiment. In the embodiment illustrated in FIG. 3, the confinement member 18 includes three liquid inlets 53 and one fluid outlet 54. In other embodiments, the confinement member can include more than one fluid outlet 54, as is illustrated, for example, in FIG. 2.

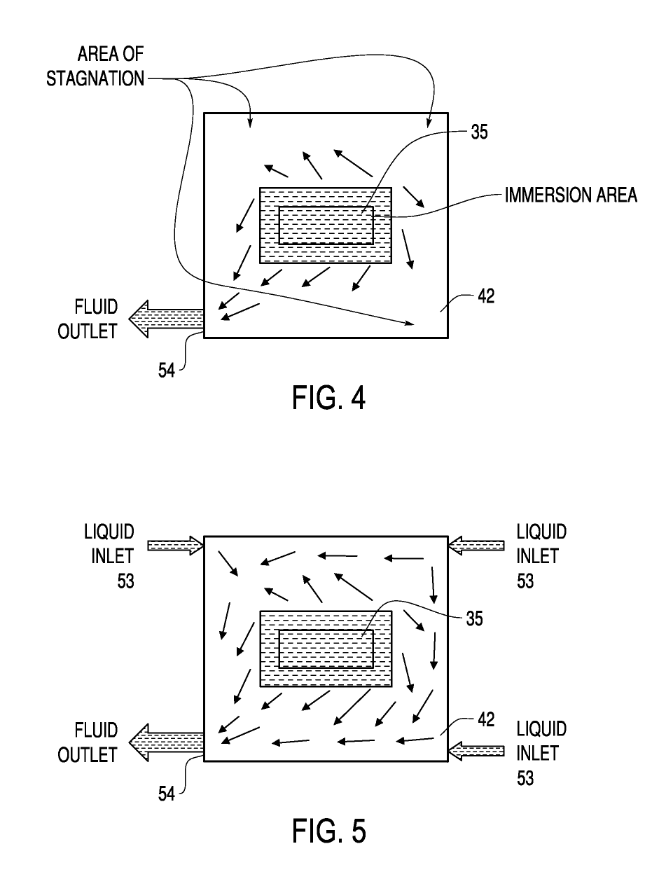

FIG. 4 illustrates a simplified plan view of a liquid confinement member that does not have liquid inlets 53. As immersion liquid 80 enters the chamber 42 through liquid-permeable member 52, immersion liquid generally flows in the direction of the arrows to the fluid outlet 54. However, some of the immersion liquid stagnates in the corners of the chamber 42 of the confinement member 18.

FIG. 5 illustrates one embodiment where three liquid inlets 53 are provided to the corners of the chamber 42. By providing liquid inlets 53 in such a manner, areas of liquid stagnation can be prevented. Although, FIG. 5 illustrates an embodiment where the liquid confinement member 18 has a square shape, the shape of the liquid confinement member can be any shape that surrounds the aperture 35.

The chamber 42 communicates with a vacuum system V1 that applies a suction force to the chamber 42 via the fluid outlet(s) 54. The suction force is sufficient to draw immersion liquid through the liquid-permeable member 52 into the chamber 42. The vacuum system V1 is controlled so that the suction force applied to the liquid-permeable member 52 is maintained below the bubble point of the liquid-permeable member 52. That is, the vacuum system V1 controls a pressure in the chamber 42 such that substantially only liquid is removed from the immersion area and/or from the surface of the substrate 26 (and/or the surface of the substrate holder) through the liquid-permeable member 52, but not gas from the surface of the substrate 26 (and/or the surface of the substrate holder). The vacuum system V1 causes the liquid to be removed from chamber 42.

The manner in which the liquid confinement member 18 is controlled to remove liquid now will be described.

A system such as the system described in US2006/0152697 A1 can be used. The system of US2006/0152697 A1 is similar to what is shown in FIG. 2 of the present application except that there is no fluid inlet 53. The system of US2006/0152697 A1 draws immersion liquid through a liquid-permeable member such as the liquid-permeable member 52 shown in Applicants' FIG. 2. The liquid fills a chamber, such as chamber 42, and the liquid is drawn from chamber 42 by a vacuum system such as system V1 of Applicants' FIG. 2. There is no means for liquid to be introduced to the chamber 42 to prevent stagnated liquid flow. Therefore, as mentioned earlier, when liquid enters the chamber 42, some of the liquid stagnates due to the eddy currents in, for example, corners of the chamber 42. In the present system, liquid inlet(s) 53 is/are provided to prevent liquid from stagnating within chamber 42.

In certain embodiments, the immersion fluid is a liquid having a high index of refraction. In different embodiments, the liquid may be pure water, or a liquid including, but not limited to, cedar oil, fluorine-based oils, “Decalin” or “Perhydropyrene.”

The liquid-permeable member 52 may be a porous member such as a mesh or may be formed of a porous material having holes typically with a size smaller than 150 μm. For example, the porous member may be a wire mesh including woven pieces or layers of material made of metal, plastic or the like, a porous metal, a porous glass, a porous plastic, a porous ceramic, a sponge or a sheet of material having chemically etched holes (for example, by photo-etching). In certain embodiments, the vacuum system V1 may be controlled so that the suction force applied to the liquid-permeable member 52 is maintained at or above the bubble point of the liquid-permeable member 52. That is, the vacuum system V1 may control a pressure in the chamber 42 such that a mixture of liquid and gas is removed from the immersion area and/or from the surface of the substrate 26 (and/or the surface of the substrate holder) through the liquid-permeable member 52.

The use of the exposure apparatus described herein is not limited to a photolithography system for semiconductor manufacturing. The exposure apparatus, for example, can be used as an LCD photolithography system that exposes a liquid crystal display device pattern onto a rectangular glass plate, or a photolithography system for manufacturing a thin film magnetic head.

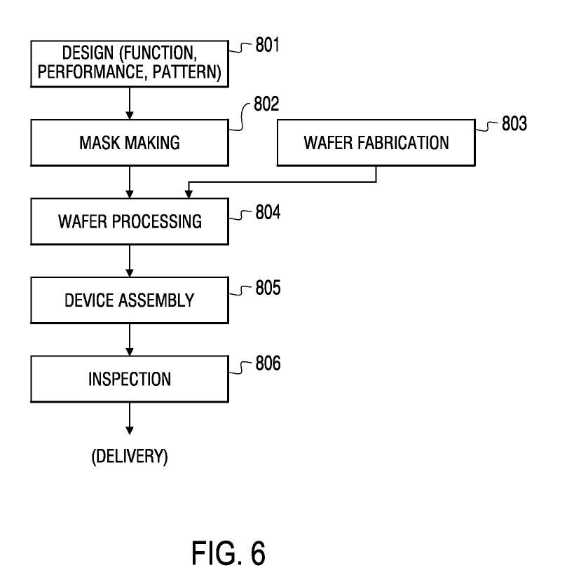

Semiconductor devices can be fabricated using the above-described systems, by the process shown generally in FIG. 6. In step 801 the device's function and performance characteristics are designed. Next, in step 802, a mask (reticle) having a pattern is designed according to the previous designing step, and in a step 803, a wafer is made from a silicon material. The mask pattern designed in step 802 is exposed onto the wafer from step 803 in step 804 by a photolithography system described hereinabove in accordance with aspects of the invention. In step 805, the semiconductor device is assembled (including the dicing process, bonding process and packaging process). Finally, the device is then inspected in step 806.

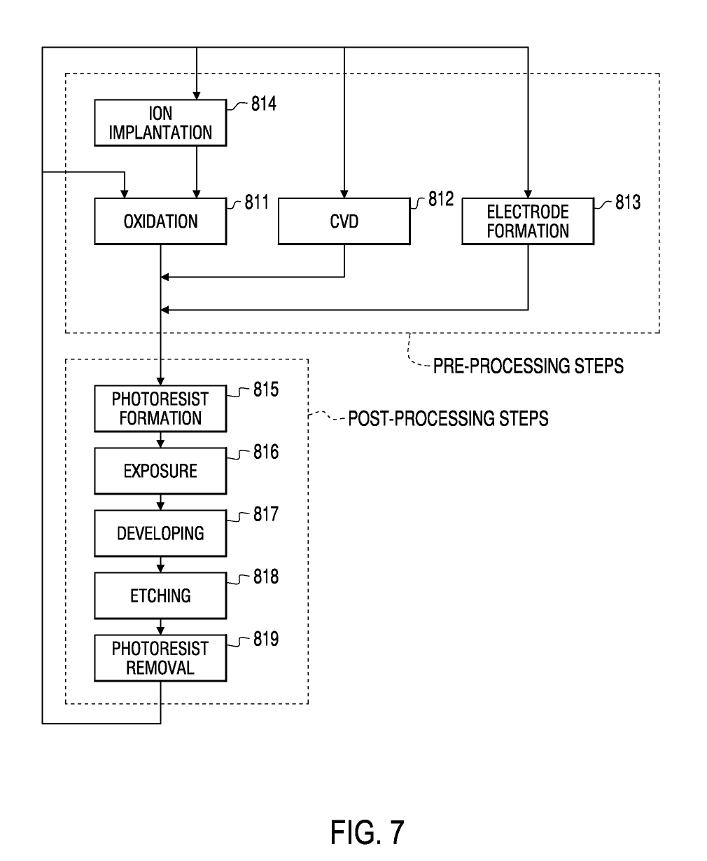

FIG. 7 illustrates a detailed flowchart example of the above-mentioned step 804 in the case of fabricating semiconductor devices. In FIG. 7, in step 811 (oxidation step), the wafer surface is oxidized. In step 812 (CVD step), an insulation film is formed on the wafer surface. In step 813 (electrode formation step), electrodes are formed on the wafer by vapor deposition. In step 814 (ion implantation step), ions are implanted in the wafer. The above-mentioned steps 811-814 form the preprocessing steps for wafers during wafer processing, and selection is made at each step according to processing requirements.

At each stage of wafer processing, when the above-mentioned preprocessing steps have been completed, the following post-processing steps are implemented. During post-processing, first, in step 815 (photoresist formation step), photoresist is applied to a wafer. Next, in step 816 (exposure step), the above-mentioned exposure device is used to transfer the circuit pattern of a mask (reticle) to a wafer. Then in step 817 (developing step), the exposed wafer is developed, and in step 818 (etching step), parts other than residual photoresist (exposed material surface) are removed by etching. In step 819 (photoresist removal step), unnecessary photoresist remaining after etching is removed. Multiple circuit patterns are formed by repetition of these preprocessing and post-processing steps.

A photolithography system (an exposure apparatus) according to the embodiments described herein can be built by assembling various subsystems in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes providing mechanical interfaces, electrical circuit wiring connections and air pressure plumbing connections between each subsystem. Each subsystem also is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. An immersion liquid confinement apparatus for confining an immersion liquid in an immersion area that includes a gap between a projection system and an object of exposure in an immersion lithography system, the apparatus also recovering the immersion liquid from the immersion area, the apparatus comprising:
a confinement member that includes an outlet and an aperture through which a patterned image is projected onto the object; and
a liquid-permeable member covering the outlet and having a first surface that faces the object and a second surface opposite the first surface, the second surface contacting a chamber, wherein
the confinement member includes at least one liquid inlet within the chamber through which a liquid is introduced into the chamber.

2. The apparatus of claim 1, wherein the confinement member includes at least one fluid outlet within the chamber through which fluid is removed from the chamber, the at least one liquid inlet being disposed within the chamber spaced away from the at least one fluid outlet.

3. The apparatus of claim 1, wherein the confinement member includes two or more of the liquid inlets.

4. The apparatus of claim 1, wherein the at least one liquid inlet is disposed at an outer periphery of the chamber.

5. The apparatus of claim 1, wherein the at least one liquid inlet is in at least one wall of the chamber.

6. The apparatus of claim 1, wherein the at least one liquid inlet is located at a position in the chamber where the immersion liquid that has passed through the liquid-permeable member stagnates.

7. The apparatus of claim 1, wherein the at least one liquid inlet is spaced away from the outlet.

8. The apparatus of claim 1, wherein the confinement member further includes an immersion liquid inlet that is outside of the chamber and that provides immersion liquid to the aperture through which the patterned image is projected onto the object.

9. The apparatus of claim 1, wherein the liquid-permeable member is a mesh.

10. The apparatus of claim 1, wherein the liquid-permeable member is a sponge.

11. The apparatus of claim 1, wherein the liquid-permeable member is a plate having holes extending through the plate.

12. An immersion lithography apparatus comprising:
a projection system having a final optical element;
a movable stage that is movable to a position below the projection system such that a gap exists between the final optical element and a surface of the stage, an immersion liquid being filled in the gap between the surface and the final optical element; and
a confinement member that maintains the immersion liquid in the gap between the surface and the final optical element, the confinement member including:
an outlet;
an aperture through which a patterned image is projected by the projection system through the immersion liquid onto the movable stage; and
a liquid-permeable member covering the outlet and having a first surface that faces the surface of the stage and a second surface opposite the first surface, the second surface contacting a chamber, wherein
the confinement member includes at least one liquid inlet within the chamber through which a liquid is introduced into the chamber without passing through the liquid-permeable member.

13. The apparatus of claim 12, wherein the confinement member includes at least one fluid outlet within the chamber through which fluid is removed from the chamber, the at least one liquid inlet being disposed within the chamber spaced away from the at least one fluid outlet.

14. The apparatus of claim 12, wherein the at least one liquid inlet is in at least one wall of the chamber.

15. The apparatus of claim 12, wherein the at least one liquid inlet is located at a position in the chamber where the immersion liquid that has passed through the liquid-permeable member stagnates.

16. The apparatus of claim 12, wherein the at least one liquid inlet is spaced away from the outlet.

17. The apparatus of claim 12, wherein the confinement member further includes an immersion liquid inlet that is outside of the chamber and that provides immersion liquid to the aperture through which the patterned image is projected onto the object.

18. The apparatus of claim 12, wherein the confinement member includes two or more of the liquid inlets.

19. The apparatus of claim 12, wherein the at least one liquid inlet is disposed at an outer periphery of the chamber.

20. The apparatus of claim 12, further comprising:
a vacuum system coupled to the chamber so as to draw the immersion liquid into the chamber through the liquid-permeable member from the first surface of the liquid-permeable member to the second surface of the liquid-permeable member.

21. The apparatus of claim 12, wherein the liquid-permeable member is a mesh.

22. The apparatus of claim 12, wherein the liquid-permeable member is a sponge.

23. The apparatus of claim 12, wherein the liquid-permeable member is a plate having holes extending through the plate.

24. The apparatus of claim 12, wherein the confinement member substantially surrounds the final optical element of the projection system.

25. The apparatus of claim 12, wherein the chamber of the confinement member includes corners and the at least one liquid inlet is configured to provide liquid to the corners of the chamber.

26. The apparatus of claim 12, wherein the stage includes a substrate holder, and an upper surface of the substrate holder, an upper surface of a substrate held by the substrate holder, or both, corresponds to the surface between which the gap is formed with the final optical element.

27. A device manufacturing method comprising:
exposing a substrate by projecting a pattern image onto the substrate through an immersion liquid and the projection system of the apparatus of claim 12; and
developing the exposed substrate.

28. A method of recovering immersion liquid from an immersion area that includes a gap between a projection system and an object of exposure in an immersion lithography system, the method comprising:
drawing the immersion liquid from the immersion area though a liquid-permeable member into a chamber disposed at least partly within a confinement member that includes an outlet and an aperture through which a patterned image is projected onto the object, the outlet including the liquid-permeable member which covers the outlet, the liquid-permeable member having a first surface that faces the object and a second surface opposite the first surface, the second surface contacting the chamber; and
supplying a liquid into the chamber through at least one liquid inlet disposed within the chamber.

29. The method of claim 28, further comprising:
removing fluid from the chamber through at least one fluid outlet disposed within the chamber spaced apart from the at least one liquid inlet.

30. The method of claim 28, wherein the at least one liquid inlet is in at least one wall of the chamber.

31. The method of claim 28, wherein the at least one liquid inlet is located at a position in the chamber where the immersion liquid that has passed through the liquid-permeable member stagnates.

32. The method of claim 28, wherein the at least one liquid inlet is spaced away from the outlet.

33. The method of claim 28, wherein the confinement member further includes an immersion liquid inlet that is outside of the chamber, the method further comprising supplying the immersion liquid to the aperture through which the patterned image is projected onto the object via the immersion liquid inlet.

34. The method of claim 28, wherein the confinement member includes two or more of the liquid inlets.

35. The method of claim 28, wherein the at least one liquid inlet is disposed at an outer periphery of the chamber.

36. The method of claim 28, wherein the immersion liquid is drawn through the liquid-permeable member into the chamber by coupling the chamber to a vacuum system.

37. The method of claim 28, wherein the confinement member substantially surrounds the aperture through which the patterned image is projected onto the object.

38. The method of claim 28, wherein the chamber of the confinement member has corners and the at least one liquid inlet is configured to provide liquid to the corners of the chamber.

39. The method of claim 28, wherein liquid is continuously supplied to the chamber through the at least one liquid inlet.

40. The method of claim 28, wherein the liquid is intermittently supplied to the chamber through the at least one liquid inlet.
